(19) United States
(12) Patent Application Publication
(10) Pub. No.: US 2026/0065286 A1
(43) Pub. Date: Mar. 5, 2026

(54) METHOD AND SYSTEM FOR MANAGING PRODUCT RECALLS

(71) Applicant: Honeywell International Inc., Charlotte, NC (US)

(72) Inventors: Varun Singh, PUNE (IN); Kartikeyan Bollapalli, Bangalore (IN); Sarath Kumar Ganesan, Bangalore (IN); Srihari Narayanaiah; Santosh Balbhadra Trivedi, Dún Laoghaire (IE); Sachin Kulkarni, Bangalore (IN)

(21) Appl. No.: 18/822,291

(22) Filed: Sep. 2, 2024

(51) Int. Cl. G06Q 30/014; G06Q 10/0637; G06Q 10/087

(52) U.S. Cl. CPC G06Q 30/014; G06Q 10/06375; G06Q 10/087

(57) ABSTRACT

A system and method for managing product recalls within a supply chain are provided. The method includes identifying and tracing products with quality issues, then initiating a recall. The recall initiation involves generating a consignee list with stakeholder information, which includes regulatory bodies, distributors, and end-users. Notifications are sent to stakeholders listed in the consignee list. The method also includes tracking and confirming the product recall method, generating compliance reports, and closing the recall. This comprehensive approach ensures efficient and accurate recall management by integrating stakeholder communication, real-time tracking, and thorough documentation, thereby enhancing regulatory compliance and minimizing operational disruptions.

### TECHNICAL FIELD

The present disclosure relates to product tracking systems and more particularly, the present disclosure relates to a method and a system for managing product recalls within a supply chain.

### BACKGROUND

The current methods for recall management are often fragmented, resulting in processes that are both cost and labor-intensive. This fragmentation arises from the use of disparate systems and manual processes that do not communicate effectively with one another. Moreover, existing track and trace platforms facilitate forward logistics tracking, but there is a pressing need for a recall management module that can streamline recall processes and extend capabilities for end-to-end supply chain tracking and recall management. Presently, recall management is largely a manual operation, with no comprehensive automated solutions available in the market. This manual approach often involves significant human intervention, which is prone to errors and inefficiencies.

Further, the financial impact of recalls can be substantial. In the automotive industry, for instance, recalls can cost manufacturers billions of dollars and lead to prolonged legal battles. Moreover, despite the potential benefits of technologies such as the Internet of Things (IoT), blockchain, and advanced data analytics, their adoption in recall management has been slow. This is partly due to the complexity and cost of implementing such systems, as well as resistance to change within organizations.

An automated solution that can track recalled products can significantly reduce recall costs and ensure compliance with regulatory requirements. Automated recall management systems can integrate with existing supply chain management platforms to provide real-time tracking and visibility of products throughout the supply chain. This integration can help identify the location of defective products quickly, facilitating faster recalls, and reducing the risk of non-compliance with regulatory standards.

Thus, the development of an automated recall management system that integrates advanced technologies and provides comprehensive end-to-end supply chain visibility is essential for modern businesses. Such a system can not only streamline recall processes and reduce costs but also enhance compliance with regulatory requirements and protect the company's reputation. As the complexity of supply chains continues to grow, the importance of efficient and effective recall management will only increase.

### SUMMARY

The present disclosure relates to a system and method for managing product recalls within a supply chain.

In an embodiment, a method for managing product recalls within a supply chain is provided. The method includes identifying and tracing products within the supply chain having quality issues and initiating a recall of the identified products. The initiation of the recall of the identified products involves generating a consignee list comprising stakeholder information based on the identified products marked for recall, where the stakeholders include at least one of the regulatory bodies, distributors, and end-users. The initiation of the recall of the identified products further involves sending a notification to the stakeholders included in the consignee list, tracking and confirming the recall of the products, and generating compliance reports of the recalled products. The method further includes closing the recall of the identified products in the supply chain.

In some embodiments, initiating the recall of the identified products includes batches of products correlated to the recalled products.

In some embodiments, identifying includes categorizing a recall class and type of recall for the identified products within the supply chain.

In some embodiments, the information related to the stakeholders comprises at least one of the following: information related to the identified products, information related to products corresponding to the batches of the identified products, information related to the location of all consignments in the supply chain, and information relates to all end-users.

In some embodiments, the method further comprises displaying the status of ongoing recalls of products on a dashboard within a user interface.

In some embodiments, sending notifications to the stakeholders, comprises sending physical and electronic messages, providing templates for regulatory notifications, and tracking acknowledgement of the notifications from the stakeholders.

In some embodiments, tracking and confirming the recall of the products comprises managing the logistics of the recalled products, tracking the status of reverse logistics operations, and confirming the receipt of returned products.

In some embodiments, generating the compliance reports of the recalled products comprises generating reports on the efficiency and compliance of the recalled products, providing proof of action and proof of destruction of the recalled products by the regulatory bodies, and documenting the closure of the recalled products.

In some embodiments, generating the consignee list includes filtering products based on a batch identity (ID) of the identified products, the range of manufacturing dates of the identified products, and multiple UID/UID ranges of the identified products, and generating information on the filtered products, including product location information within the supply chain.

In some embodiments, the method further includes communicating with regulatory bodies regarding the identification of the quality issues with products and managing the recall of the products.

In yet another embodiment, a recall management system for managing product recalls within a supply chain is disclosed. The recall management system includes an identification and tracking module, a processing module, a communication module, and a terminating module. The identification and tracking module identifies and tracks products within the supply chain having at least one quality issue. The processing module is configured to initiate a recall of the identified products in the supply chain by generating a consignee list comprising stakeholder information based on the identified products marked for recall, where the stakeholders include at least one of the regulatory bodies, distributors, and end-users. The processing module further tracks and confirms the recall of the products and generates compliance reports of the recalled products. The communication module, being in operative communication with the processing module, sends notifications to the stakeholders included in the consignee list. The terminating module closes the recall of the identified products in the supply chain.

In yet another embodiment, a non-transitory computer-readable medium having stored thereon computer-readable instructions is disclosed. The computer-readable instructions, when executed by a processor, cause the processor to identify and trace products within the supply chain having at least one quality issue. The computer-readable instructions further cause the processor to initiate a recall of the identified products in the supply chain by generating a consignee list comprising stakeholder information based on the identified products marked for recall, where the stakeholders include at least one of the regulatory bodies, distributors, and end-users, sending a notification to the stakeholders included in the consignee list, and tracking and confirming the recall of the products and generate compliance reports of the recalled products, and close the recall of the identified products in the supply chain.

The product recall management systems and methods of the present subject matter provide enhanced accuracy and efficiency in identifying and tracking products with quality issues within the supply chain. Leveraging steps including generating consignee lists, significantly reduces the time and effort required to pinpoint defective products.

Additionally, the automated generation of the consignment lists and notifications ensures that all relevant stakeholders, including regulatory bodies, distributors, and end-users, are promptly informed of recall actions. This reduces the communication lag and minimizes the risk of legal penalties due to delayed notifications.

Further, the system's capability to track and confirm the product recall method in real time allows for more effective management of reverse logistics operations. This includes tracking the return of recalled products, managing their logistics, and confirming their receipt.

The automated generation of compliance reports provides comprehensive documentation of the recall method, demonstrating adherence to regulatory requirements and providing proof of action. Overall, the technical effect of the disclosure is a streamlined, integrated, and automated recall management method that enhances operational efficiency, reduces costs, and ensures regulatory compliance, thereby protecting both the company's financial interests and its reputation.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1(a)-(c) illustrates a flowchart of a product recall method according to an embodiment of the disclosure;

FIG. 2 illustrates a flowchart related to managing data requirements for the product recall method ensuring comprehensive tracking and reporting according to an embodiment of the disclosure;

FIG. 3(a)-(b) illustrates the data requirement for the product recall method according to an embodiment of the disclosure;

FIG. 4(a)-(b) illustrates a method for consignment list generation and notification dispatch within the context of the product recall method according to an embodiment of the disclosure;

FIG. 5(a)-(b) illustrates stages of the product recall method according to an embodiment of the disclosure;

FIG. 6 illustrates a table displaying the roles and responsibilities of various personas involved in the product recall method according to an embodiment of the disclosure;

FIG. 7 illustrates a flowchart of a method for managing product recalls within a supply chain according to an embodiment of the disclosure;

FIG. 8 illustrates a recall management system according to an embodiment of the disclosure; and

FIG. 9 illustrates a schematic diagram of a communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

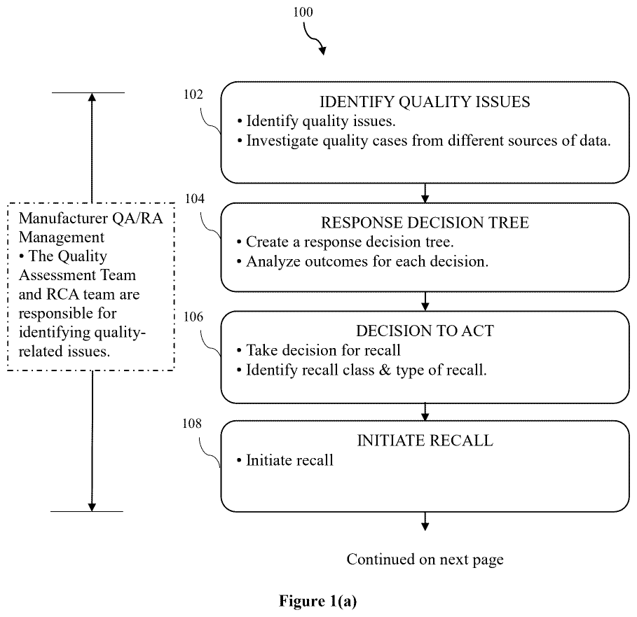

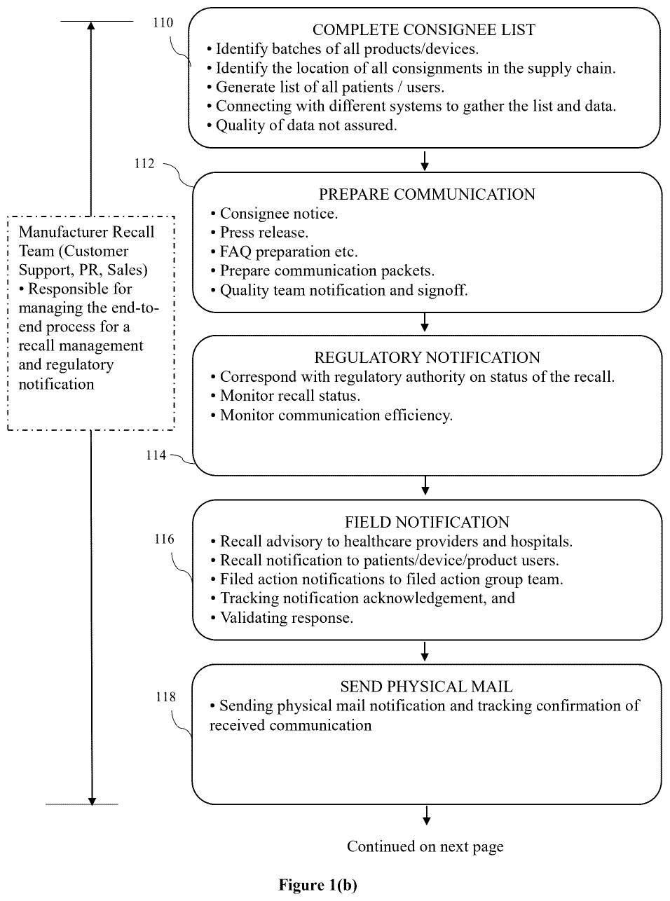

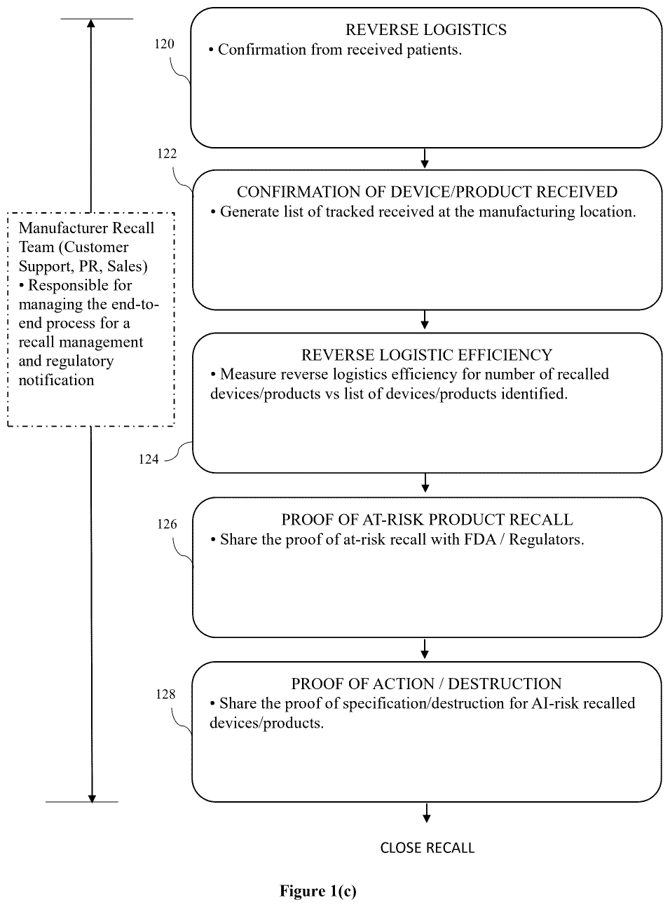

FIG. 1(a)-(c) illustrates a flowchart of a product recall method 100, hereinafter referred to as “method 100,” designed to ensure efficiency and effectiveness throughout the recall method in accordance with one or more embodiments of the present disclosure.

The disclosed method 100 is structured to manage product recalls effectively across a diverse array of industries, including, but not limited to, medical products, pharmaceuticals, automotive, and consumer goods. For instance, method 100 can be employed to manage product (hereinafter interchangeably referred to as “device”) recalls involving a combination of these industries, in an exemplary embodiment, a pharmaceutical company can recall a defective medical device or an automotive manufacturer dealing with a defect in a vehicle component that affects both medical devices and consumer vehicles. The steps of method 100, as described in connection with the embodiments disclosed herein, may be realized through a variety of implementations, including directly in hardware, via firmware, through a software module executed by a computing system, or through any practical combination of these approaches.

At step 102, a product is identified with quality issues. The identification of the quality issues is done by investigating different data sources and pinpointing the products in question. The identification process is critical as it sets the foundation for the entire recall management process. In one embodiment, the method 100 utilizes advanced machine learning algorithms to analyze historical data and predict potential quality issues before they become widespread. These algorithms identify patterns and anomalies in the data that indicate a defect or quality issue, allowing for proactive measures to be taken. In another embodiment, the Quality Assessment Team and Root Cause Analysis (RCA) team are responsible for identifying quality-related issues.

In another embodiment, Internet of Thing (IoT) devices are integrated to provide real-time data on device performance and quality. These devices can continuously monitor various parameters such as temperature, humidity, pressure, and other environmental factors that might affect the device quality. By analyzing this real-time data, deviations from expected performance standards is detected, triggering alerts for further investigation. In an exemplary embodiment, a sudden spike in temperature in a medical product could indicate a malfunction, prompting immediate action to prevent potential harm to patients.

In an embodiment, the quality issues identification may incorporate feedback mechanisms from end-users and field data reports. This includes collecting and analyzing customer complaints, warranty claims, and service reports. In an exemplary embodiment, the method 100 employs natural language processing (NLP) to sift through textual data from these sources, identifying recurring issues that could signify a broader problem. By triangulating data from multiple sources-historical trends, real-time monitoring, and user feedback—the method 100 ensures a robust and comprehensive approach to identifying quality issues.

At step 104, the method 100 involves creating a response decision tree. The decision tree analyzes the outcomes of various responses to the identified quality issues, helping to determine the most appropriate action. In an exemplary embodiment, the decision tree incorporates weighted factors such as the severity of the issue, cost implications, and potential impact on customers to facilitate decision-making.

At step 106, a decision to act is made based on the analysis from the response decision tree created in the step 104. The decision to act involves determining whether a recall is necessary and, if so, identifying the class and type of recall required. In one embodiment, the method 100 utilizes automated decision-making processes where predefined thresholds and criteria are applied. For instance, if the severity of the identified issue surpasses a certain threshold, the recall is automatically categorized as either Class I, II, or III, depending on the potential risk to consumers.

In another embodiment, the decision-making process includes a manual override option for human intervention, providing an added layer of scrutiny. This is particularly useful in complex scenarios where contextual understanding and expert judgment are essential. For example, if a medical product shows a minor defect that does not immediately impact functionality but has long-term safety implications, human experts can review the data and make an informed decision on the appropriate recall strategy. This combination of automated and manual processes ensures that all aspects of the issue are thoroughly evaluated, balancing speed with accuracy.

Further, the method 100 incorporates a multi-criteria decision analysis (MCDA) framework to evaluate different factors influencing the recall decision. These factors include the severity of the quality issue, the number of affected units, the geographical distribution of the products, and the potential impact on the brand's reputation. By using MCDA, the method 100 provides a structured approach to weighing these factors and arriving at a balanced decision. This ensures that the recall decision is not solely based on a single parameter but considers a holistic view of the situation, enhancing the effectiveness and efficiency of the recall management process.

At step 108, the recall is initiated. The recall initiation includes identifying the batches of affected products and determining the locations of consignments within the supply chain. A comprehensive list of all affected products and their locations is generated to ensure thorough coverage. In an alternate embodiment, the method 100 uses blockchain technology to track and verify the location data. In an embodiment, steps 102-108 are performed by the manufacturer, and QA/RA management team.

At step 110, the method 100 involves completing/generating the consignee list, a crucial step in managing an effective recall. The consignee list completing step entails identifying batches of all products and determining the locations of all consignments within the supply chain. In an exemplary embodiment, completing the consignee list involves generating a comprehensive list of all patients or users and connecting with different systems to gather the necessary data. This ensures that the recall can be efficiently and accurately executed by providing a detailed account of all affected products and their locations.

In one embodiment, the method 100 employs an integrated database that consolidates information from various sources, such as warehouse management systems, distributor records, and end-user registrations. By using unique identifiers like batch IDs, manufacturing dates, and UID ranges, the method filters and retrieves specific product details. This integrated approach ensures that all relevant data points are captured, providing a holistic view of the distribution network and facilitating the accurate identification of consignees.

Another embodiment includes leveraging advanced data analytics to cross-reference and verify the accuracy of the consignee information. The discrepancies and inconsistencies can be detected by comparing data from multiple sources, such as internal records, third-party logistics (3PL) providers, and end-user feedback. This ensures that the consignee list is accurate and up-to-date, minimizing the risk of overlooking affected products.

In an embodiment, the consignee list completion includes provisions for handling products that are not traceable. In such cases, immediate audit actions are initiated to locate these products and include them in the product recall method. The detailed steps for internal notification, notification to distributors and 3PL providers, end-user notification, and regulatory notification are explained in the later part of the description and are all based on the comprehensive consignee list generated in step 110. This ensures that all stakeholders are promptly and accurately informed about the recall, facilitating a coordinated and efficient response. The entire process is overseen by a quality team, business head, PR head, and customer support, ensuring that all notifications are approved and dispatched through various communication channels such as email, SMS, and print, as necessary.

At step 112, all communications related to the recall are prepared. This includes press releases, Frequently Asked Questions (FAQ) documents, and communication packets for different stakeholders. In an embodiment, customizable templates and an approval workflow ensure all communications are reviewed by the quality team before dissemination. In another embodiment, the method 100 comprises preparing comprehensive communications for stakeholders, such as press releases, FAQ documents, and tailored communication packets. Customizable templates and an approval workflow ensure that all communications undergo a thorough review by the quality team before dissemination, enhancing accuracy and consistency. An alternate embodiment may incorporate machine learning algorithms to personalize communications based on stakeholder profiles, improving engagement and responsiveness. In an exemplary embodiment, a user-friendly interface can be used to allow stakeholders to preview and approve communications in real time, fostering collaboration and ensuring the timely dissemination of critical information. In an exemplary embodiment, automotive recalls are used where clear and effective communication is essential to mitigate brand reputation risks and ensure consumer safety.

At step 114, regulatory notifications are managed. Managing the regulatory notification involves corresponding with regulatory authorities regarding the recall status and monitoring the recall method to ensure compliance with regulations. In an embodiment, the method 100 can automate the generation and submission of required regulatory reports to streamline the process.

In an embodiment, the method 100 facilitates seamless correspondence with regulatory authorities to update them on the recall status and ensure compliance with regulatory standards. This includes automating the generation and submission of required regulatory reports, streamlining the process and minimizing manual effort. An alternate embodiment may enhance this process by integrating predictive analytics to forecast regulatory responses based on historical data, thereby proactively addressing potential compliance issues. An exemplary embodiment demonstrates the capability to archive all regulatory communications securely, providing audit trails and timestamps for each interaction, ensuring transparency and compliance verification.

At step 116, field notifications are handled. The handing of the field notification involves sending recall advisories to healthcare providers, hospitals, and patients, and tracking acknowledgement and validation of responses to ensure notifications are received and understood. In an exemplary embodiment, reminder notifications are automatically sent if acknowledgments are not received within a specified timeframe.

In an embodiment, the method 100 incorporates a comprehensive approach to managing regulatory notifications, ensuring compliance and efficient communication with stakeholders and regulatory authorities. This includes establishing seamless correspondence channels with regulatory authorities to provide timely updates on the recall status and compliance measures. The method 100 also includes monitoring the recall status in real-time, enabling stakeholders to track progress and regulatory adherence throughout the recall lifecycle. Additionally, step 114 enhances communication efficiency by implementing streamlined processes for data encryption and decryption, safeguarding sensitive information during transmission and storage. An alternate embodiment may explore advanced encryption methodologies, such as homomorphic encryption, to further bolster data security while preserving operational agility and regulatory compliance. An exemplary embodiment of step 114 showcases user-friendly interfaces and intuitive tools that empower stakeholders to manage encryption keys effectively and monitor encryption status with clarity and precision.

At step 118, mail notifications are sent out, and confirmation of received communication is tracked. Integration with postal services automates the mailing process and tracks delivery status. In another embodiment, digital communication methods such as emails or SMS may be used alongside physical mail to ensure broader reach and automatic reminders for unacknowledged notifications.

In one embodiment, step 118 involves sending notifications to one or more stakeholders, which includes methods that can ensure effective communication and compliance. In an embodiment, the notifications sending includes sending both physical and electronic messages tailored to reach stakeholders through diverse communication channels. Additionally, the process may utilize one or more templates specifically designed for regulatory notifications, ensuring clarity and conformity with regulatory requirements. Furthermore, step 118 entails tracking the acknowledgement of these notifications from stakeholders, thereby ensuring accountability and compliance throughout the notification process. Step 120 entails reverse logistic confirmation. In an embodiment, the reverse logistic confirmation is received from one or more stakeholders.

At step 122, the receipt of recalled products is confirmed. This step tracks and confirms the arrival of recalled products at the manufacturing location. Integration with inventory management systems automatically updates the status of received products to maintain accurate records. In an embodiment, the method includes tracking and confirming the receipt of recalled products at designated locations, integrating seamlessly with inventory management systems to update the status of received products automatically. In an alternate embodiment, RFID or IoT sensors provide real-time tracking and location data, optimizing logistics and minimizing handling errors. An exemplary embodiment features automated reconciliation processes that compare received products against the recall list, flagging discrepancies for immediate resolution.

At step 124, the efficiency of reverse logistics is measured. The measuring of the efficiency involves comparing the number of recalled products against the identified list to assess the efficiency of the reverse logistics process. In an embodiment, advanced analytics can identify bottlenecks and improve efficiency through real-time monitoring. Measuring the efficiency of reverse logistics by comparing the number of recalled products against the identified list and assessing process bottlenecks through advanced analytics. An alternate embodiment may leverage blockchain technology to create an immutable record of each product's journey through the reverse logistics chain, enhancing transparency and accountability. In an exemplary embodiment, utilizing predictive analytics to optimize logistics routes and scheduling, reducing transportation costs and improving turnaround times.

At step 126, proof of action or destruction is provided. This step generates detailed reports and photographic evidence of specific actions taken or destruction of recalled products, which can be shared with regulators to ensure compliance. The method 100 generates detailed reports and photographic evidence documenting specific actions taken or destruction of recalled products, ensuring compliance with regulatory requirements. An alternate embodiment utilizes AI-powered image recognition to verify destruction processes automatically, enhancing accuracy and reducing manual oversight. An exemplary embodiment incorporates blockchain technology to create digital certificates of destruction, providing tamper-proof documentation for regulatory audits and legal purposes.

At step 128, proof of the at-risk product recall is shared with regulatory bodies. This step ensures that all at-risk products are successfully recalled, providing digital certificates of destruction and blockchain verification to ensure tamper-proof documentation. Step 128 ensures that all at-risk products are successfully recalled, providing digital certificates of destruction and utilizing blockchain verification to ensure tamper-proof documentation. An alternate embodiment may enhance security by implementing multi-factor authentication for accessing recall documentation, and safeguarding sensitive information from unauthorized access. An exemplary embodiment demonstrates interoperability with global regulatory frameworks, facilitating seamless data exchange and compliance verification across international jurisdictions.

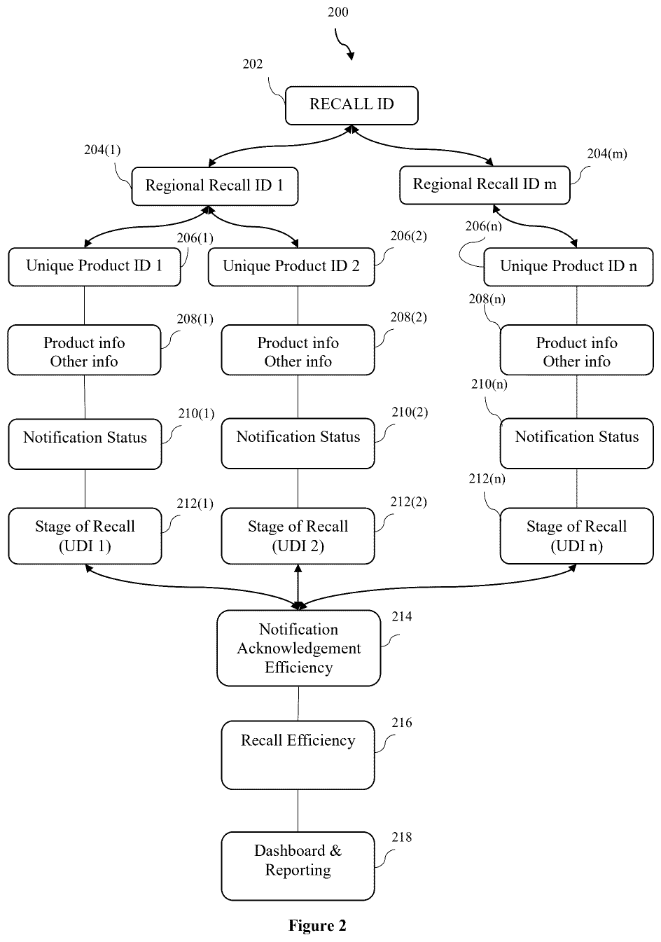

FIG. 2 illustrates a flowchart related to managing data requirements for the product recall method ensuring comprehensive tracking and reporting according to an embodiment of the disclosure. In an embodiment, the above-discussed decision to act comprises the steps of managing data requirements for the product recall method. The method of managing data requirements begins with a central recall ID 202, which serves as the unique identifier for a specific recall event. This ID 202 is the root of the entire recall management process, grouping all related data and activities. Under the main Recall ID 202, multiple Regional Recall IDs 204(1) to 204(m) (where m is a positive integer) represent recall actions taken in different geographical regions or markets. Each Regional Recall ID 204(1) to 204(m) is associated with a specific region where the recall activities are being tracked and managed. For each Regional Recall ID 204(1) to 204(m), there are several unique product IDs 206(1), 206(2), . . . 206(n) (where n is a positive integer), which correspond to individual units of the product being recalled. These Unique Product IDs 206(1), 206(2), . . . 206(n) ensure that every affected unit can be individually tracked throughout the product recall method.

Each Unique Product ID 206(1), 206(2), . . . 206(n) links to a set of detailed information, including product information and other information 208(1), 208(2), . . . 208(n). The product information section contains details including, but not limited to, the model number, batch number, and other identifying attributes, while other information includes manufacturing date, location, and any other pertinent data. Additionally, each unique product ID 206(1), 206(2), . . . 206(n) has an associated notification status 210(1), 210(2), . . . 210(n), indicating whether the recall notification has been sent to relevant stakeholders (e.g., distributors, customers) and whether any acknowledgement has been received.

The product recall method also involves tracking the stage of recall 212(1), 212(2), . . . 212(n) for each product unit, covering various phases such as initial notification, return or collection of the product, inspection and verification, repair or replacement, and final disposition. Each stage is crucial for ensuring the recall method progresses as planned and that all affected units are accounted for.

Apart from the hierarchical structure discussed above, the recall management process includes additional metrics to ensure effectiveness. Notification acknowledgement efficiency 214 measures how efficiently and promptly the notifications were acknowledged by recipients, providing insight into the communication process during a recall. Recall Efficiency 216 tracks the overall efficiency of the product recall method, including the time taken for each stage, the number of products successfully recalled, and any issues encountered. A comprehensive dashboard & reporting system 218 is essential for real-time monitoring and management, offering visual and analytical tools to track progress, identify bottlenecks, and generate reports for regulatory compliance and internal assessment.

In an embodiment, the recall management system is implemented as a software application integrating with existing product lifecycle management (PLM) and customer relationship management (CRM) systems. This software would automatically generate and assign Recall IDs and Regional Recall IDs based on predefined criteria, including, but not limited to, sales regions or distribution channels. It would also automate the notification process, sending out recall notices via email, SMS, or other communication channels, and tracking acknowledgment status. A detailed dashboard would provide real-time insights into recall status, the number of units affected, and progress at each stage.

In another embodiment, the system utilizes barcodes or RFID tags to uniquely identify each product unit (Unique Product ID). Scanners at various points in the product recall method would update the system in real-time, ensuring accurate tracking and reducing manual errors.

The hierarchical approach ensures tracking of every aspect of the recall, from the initial recall notice to the final resolution for each product unit. By breaking down the product recall method into manageable levels and stages, the system allows for detailed monitoring and reporting, ensuring regulatory compliance and effective communication with all stakeholders involved.

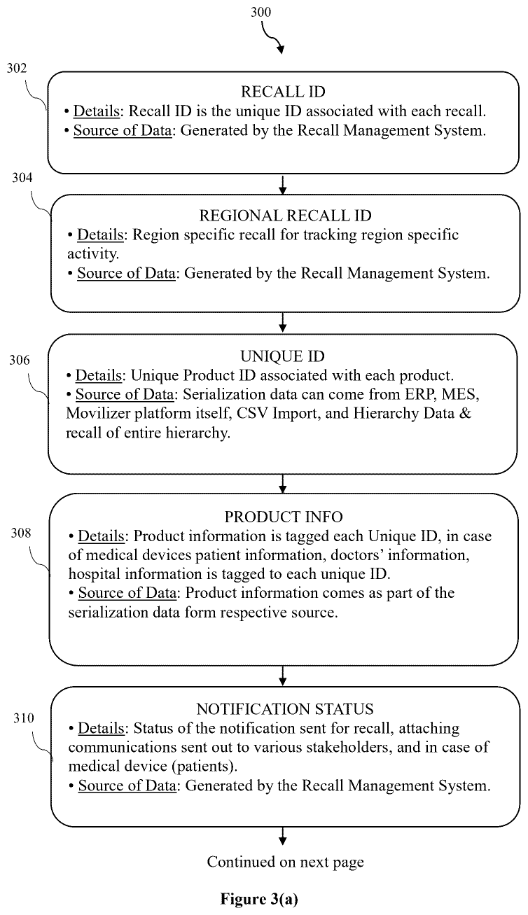

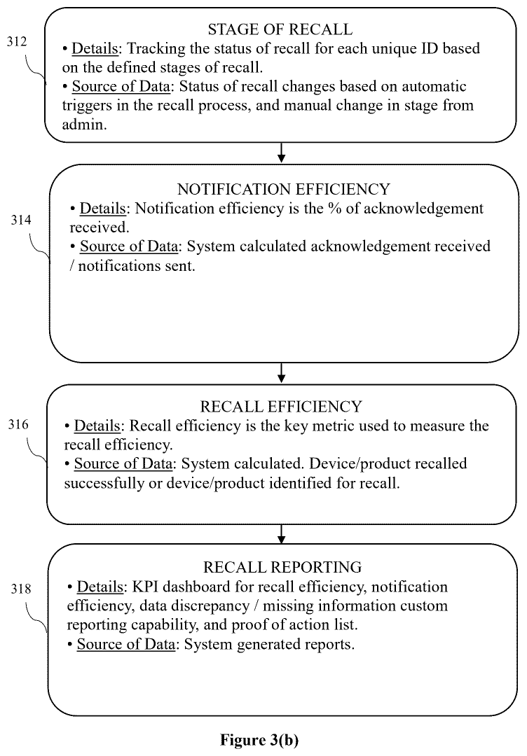

FIG. 3 illustrates the data requirement for the product recall method according to an embodiment of the disclosure. At the top of this hierarchy is the recall ID, a unique identifier assigned to each recall event, step 302. This ID is used for tracking and managing the recall and is generated by the recall management system.

At step 304, each Recall ID is associated with multiple regional recall IDs. These region-specific IDs enable the tracking of recall activities in different geographical areas, also generated by the recall management system. Each Regional Recall ID is linked to several Unique IDs, step 306, which correspond to individual units of the recalled product. These unique identifiers ensure that each affected unit can be tracked individually. The serialization data for these IDs can come from various sources such as ERP systems, MES, the Mobilizer platform, CSV imports, and hierarchy data from the recall management system.

Each Unique ID is further detailed with product information, in step 308. This information includes product details such as patient information, doctor's information, and hospital information in the case of medical products. The product information is tagged to each Unique ID and comes from the serialization data of respective sources. Additionally, the notification status for each Unique ID indicates whether recall notifications have been sent to stakeholders, step 310. In an embodiment, the stakeholders include patients for medical products. This status is generated by the recall management system.

The product recall method also involves tracking the stage of recall for each Unique ID, step 312. This encompasses various stages such as initial notification, return or collection, inspection, repair or replacement, and final disposition. The status of these stages changes based on automatic triggers in the product recall method or manual updates by an administrator. The efficiency of notifications is measured by notification efficiency, step 314, which is the percentage of acknowledgments received. This metric is system-calculated based on acknowledgments received and notifications sent.

Recall Efficiency is another critical metric, measuring the overall effectiveness of the product recall method, step 316. It includes data on the number of successfully recalled products and those identified for recall, calculated by the system. The final component of the recall management process is recall reporting, step 318. This includes a KPI dashboard for recall efficiency, notification efficiency, data discrepancies, custom reporting capabilities, and a proof of action list. The data for these reports is system-generated.

In an embodiment, the recall management system is implemented as a software application integrated with existing product lifecycle management (PLM) and customer relationship management (CRM) systems. This software would automatically generate and assign Recall IDs and Regional Recall IDs based on predefined criteria such as sales regions or distribution channels. It would automate the notification process, send recall notices via email, SMS, or other communication channels, and track acknowledgment status. A detailed dashboard would provide real-time insights into the recall status, the number of units affected, and progress at each stage.

In another embodiment, the system could use barcodes or RFID tags to uniquely identify each product unit (Unique ID). Scanners at various points in the product recall method would update the system in real-time, ensuring accurate tracking and reducing manual errors. Overall, this hierarchical approach ensures meticulous tracking of every aspect of the product recall method, from the initial recall notice to the final resolution for each product unit. By breaking down the product recall method into manageable levels and stages, the system allows for detailed monitoring and reporting, ensuring regulatory compliance and effective communication with all stakeholders involved.

The disclosed data requirement process provides a comprehensive view of the recall management process, emphasizing the importance of unique identifiers at each level and the need for detailed tracking and reporting. By leveraging modern data sources and automated systems, the recall management process becomes streamlined and robust, ensuring that all affected products are swiftly and accurately addressed.

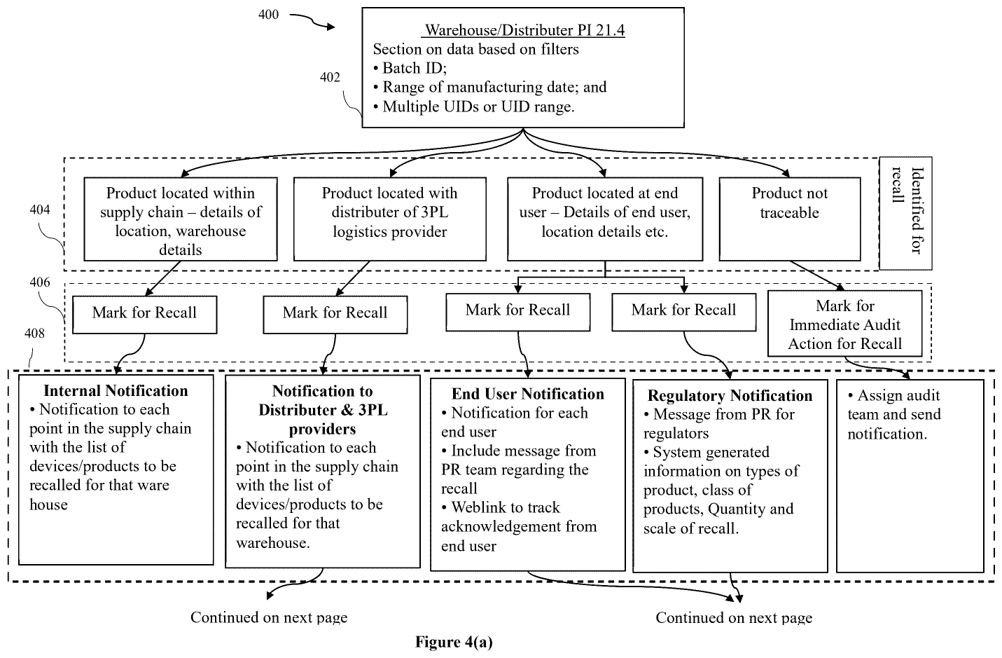

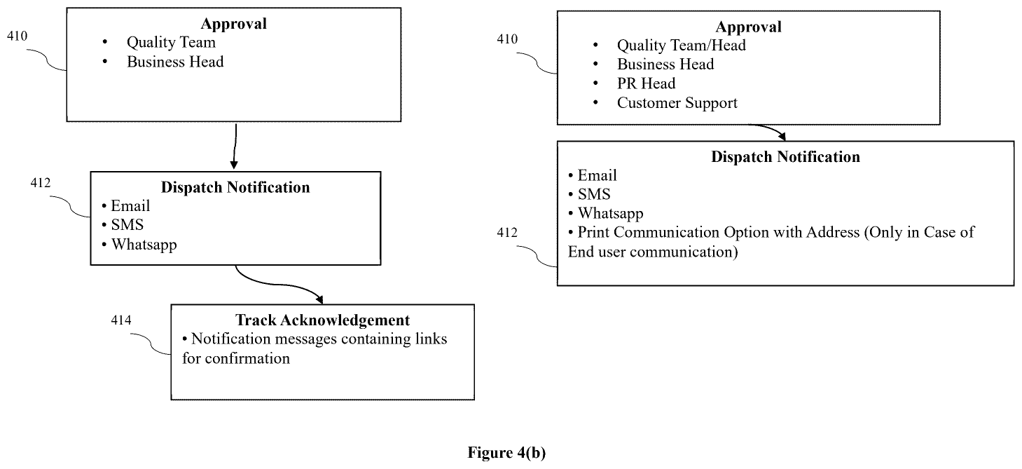

FIG. 4 illustrates a method for consignment list generation and notification dispatch within the context of the product recall method according to an embodiment of the disclosure. At step 402, products are filtered, which is performed at the warehouse or distributor level. Products are filtered based on specific criteria, such as Batch ID, range of manufacturing dates, and multiple UIDs or UID ranges. This process helps isolate the exact products subject to recall, ensuring that only the affected units are targeted. Advanced embodiments employ automated filtering systems or cloud-based platforms, enabling real-time data access and reducing manual errors.

At step 404, a list of products with detailed identification is generated. Once the products are filtered, the next step is generating a comprehensive list categorizing the products based on their current location and status. The list includes details for products located within the supply chain (including specific warehouse details), products with distributors or 3PL logistics providers, products at end-user locations (with end-user and location specifics), and products that are not traceable. Integration with inventory management systems or the use of GPS and IoT products can enhance the accuracy and real-time updating of this list, ensuring precise tracking of each product.

At step 406, recalls are marked and notifications are generated. The identified products are marked for recall, and appropriate notifications are generated. For products within the supply chain, internal notifications are sent to each point in the supply chain, detailing the products to be recalled. For products with distributors or 3PL providers, notifications are generated and sent to these entities, including detailed recall lists. For products at end-user locations, notifications are sent to end users, including a message from the PR team, a web link for acknowledgement tracking, and regulatory notifications with detailed recall information. Products that are not traceable are marked for immediate audit action, and notifications are sent to assign an audit team. Automated notification systems and multi-channel dispatch methods ensure comprehensive coverage and timely communication.

At step 410, the generated notifications are then sent for approval to ensure their accuracy and compliance. Notifications related to the internal supply chain and distributors are reviewed and approved by the quality team and business head. Notifications intended for end users and regulatory bodies undergo a more rigorous approval process, involving the quality team, business head, PR head, and customer support. Embodiments include automated approval workflows with digital signatures or collaborative platforms for real-time review and approval.

Upon approval, at step 412, the notifications are dispatched to the relevant stakeholders. Notifications for the supply chain and distributors are sent via multiple channels, such as email, SMS, and WhatsApp. Notifications for end users and regulatory bodies are dispatched through these channels as well as via print communication options for enhanced reach and compliance. A centralized dispatch system ensures efficient management and monitoring of the notification process, while personalized dispatch methods tailor messages based on recipient preferences and locations.

The final step involves tracking the acknowledgement of the notifications to ensure receipt and action, step 414. Notifications include confirmation links for recipients to acknowledge the recall. Real-time tracking systems monitor these acknowledgements, providing a dashboard that displays the status of each notification. Automated reminders are sent to stakeholders who have not acknowledged the notifications, ensuring comprehensive coverage and compliance.

By implementing these detailed steps and embodiments, the method for consignment list generation and notification dispatch ensures an efficient, accurate, and compliant product recall management process. This comprehensive approach leverages advanced technologies and methodologies to streamline recall operations, enhance communication, and ensure regulatory compliance, ultimately safeguarding consumer safety and maintaining product integrity.

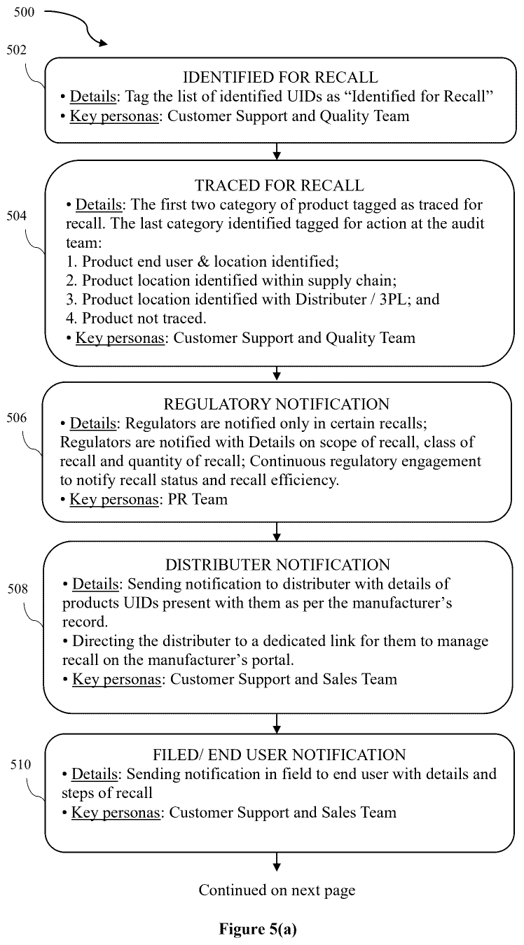

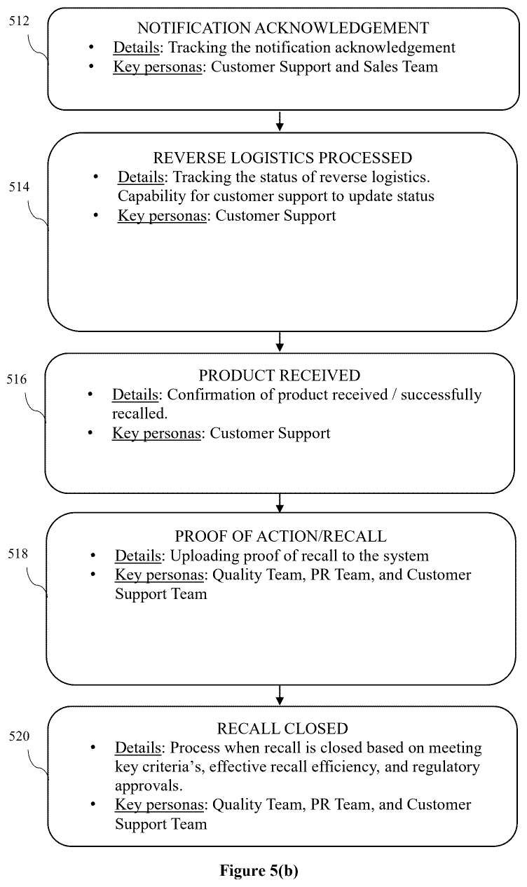

FIG. 5(a)-(b) illustrates stages of the product recall method according to an embodiment of the disclosure. The product recall method is organized into several critical stages to ensure thorough and efficient execution. The first stage, identified for recall, step 502, involves tagging the list of identified UIDs (Unique Identification Numbers) as “Identified for Recall.” This tagging signifies that these specific products or products are subject to recall based on detected issues or defects. Key personas involved in this stage are the Customer Support and Quality Team. In an embodiment, an automated tagging system can be employed to scan through product databases, identify, and tag UIDs based on predefined recall criteria, thereby reducing manual effort and increasing accuracy. For instance, a pharmaceutical company might identify a batch of medication with potential contamination and tag all affected UIDs as “Identified for Recall.”

At the step 504, products are categorized and tagged for recall with specific actions assigned based on their location. The categories include products with end users and their locations, products identified within the supply chain, products identified with distributors or third-party logistics providers (3PL), and products that cannot be traced. Key personas here are again the Customer Support and Quality Team. Real-time tracking integration, utilizing GPS and IoT products, can enhance the accuracy of tracing and categorizing products. In an exemplary embodiment, an electronics manufacturer might trace recalled products through their supply chain, identifying units at warehouses, distributors, and end users, while untraceable units are flagged for further investigation.

Step 506 involves notifying regulators in specific recall scenarios, and providing details on the scope, class, and quantity of the recall. Continuous engagement with regulators ensures they are updated on the recall status and efficiency. The PR Team plays a crucial role in this stage. Advanced embodiments might include automated regulatory reporting systems that generate and send detailed reports to regulatory bodies automatically. For example, a food company might notify regulatory authorities about a large-scale recall of a contaminated product batch, providing detailed information on the scope and progress of the recall.

At step 508, notifications are sent to distributors, detailing the products' UIDs present with them as per the manufacturer's records. Distributors are directed to a dedicated link to manage the recall on the manufacturer's portal. Key personas involved are the Customer Support and Sales Team. A secure online portal can be used for distributors to access recall details, confirm receipt of notifications, and update recall statuses. For instance, an automotive manufacturer might send notifications to all its distributors, directing them to a portal where they can manage the product recall method for defective parts.

Following this, step 510 involves sending notifications to end users in the field, providing details and steps of the product recall method. Key personas here are the Customer Support and Sales Team. Multi-channel notification systems, including email, SMS, and physical mail, ensure that end users are informed and can take necessary actions. For example, a consumer electronics company might send recall notifications to customers, explaining the issue, product recall method, and how to return the affected products.

The step 512 focuses on tracking the acknowledgement of notifications sent to distributors and end users to ensure they have received and are aware of the recall. Key personas involved are the Customer Support and Sales Team. A real-time dashboard can track and display acknowledgement statuses, sending reminders to non-responsive recipients. For instance, a medical product company might monitor acknowledgements from hospitals and clinics, ensuring they are aware of the recall and have acknowledged receipt of the notifications.

In the step 514, the status of reverse logistics is tracked, enabling customer support to update the status of returned products. Key personas here are the Customer Support. An integrated reverse logistics system can track the return and handling of recalled products. For example, an appliance manufacturer might track the return of recalled products from customers, updating the status in real-time as products are received and processed.

At step 516, the receipt of recalled products is confirmed, ensuring they have been successfully returned. Key personas involved are the Customer Support. An automated confirmation system can be used to confirm the receipt of recalled products and update the recall management system. For instance, a toy manufacturer might confirm receipt of returned toys from various retailers and end users, updating the system to reflect the successful recall.

At step 518, proof of recall actions is uploaded to the system, including documentation and photographic evidence. Key personas involved are the Quality Team, PR Team, and Customer Support Team. Blockchain technology can be employed to create tamper-proof records of recall actions and proof of product destruction. For example, a chemical company might upload photographic evidence and documentation of the disposal of recalled hazardous materials, ensuring regulatory compliance.

Finally, step 520 involves closing the product recall method based on meeting key criteria, achieving effective recall efficiency, and obtaining regulatory approvals. Key personas involved are the Quality Team, PR Team, and Customer Support Team. A recall closure dashboard can track recall metrics and criteria, facilitating the closure process once all conditions are met. For instance, a pharmaceutical company might close a recall after verifying that all affected batches have been returned, properly disposed of, and regulatory authorities have approved the closure.

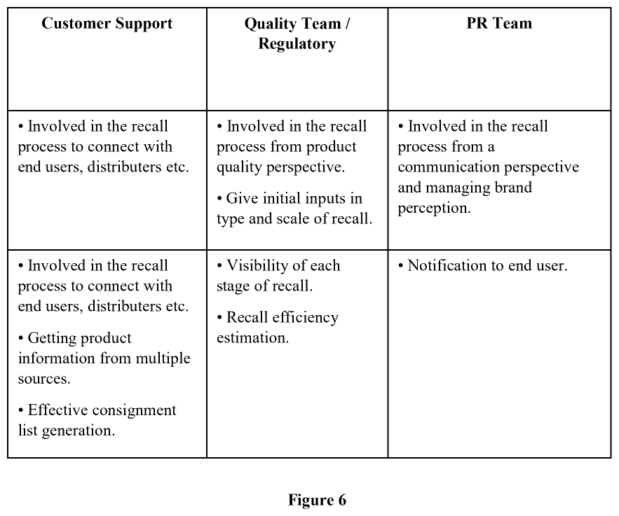

FIG. 6 illustrates a table displaying roles and responsibilities of various personas involved in the product recall method according to an embodiment of the disclosure. These personas are integral to different stages of the recall, each bringing their unique expertise and perspective to the process. Firstly, Customer Support plays a crucial role in the product recall method, acting as the primary point of contact with end users, distributors, and other stakeholders. Their responsibilities include connecting with end users and distributors to disseminate recall information and gather product details from multiple sources. Effective consignment list generation is a key task, ensuring that all identified products are accurately documented and tracked throughout the product recall method. In an embodiment, utilization of multi-channel communication platforms (email, SMS, phone calls) to reach out to stakeholders efficiently. In an exemplary embodiment, a consumer electronics company's customer support team uses an integrated CRM system to contact customers who purchased a defective batch of products, providing instructions on how to return the products.

The Quality Team and Regulatory personnel are involved in the product recall method from a product quality perspective. They provide initial inputs regarding the type and scale of the recall, ensuring that the recall scope is accurately defined. They maintain visibility of each stage of the recall and are responsible for estimating recall efficiency. This team ensures that all quality and regulatory standards are met throughout the product recall method.

Implementing quality assurance systems to monitor and document product quality issues that trigger recalls. A pharmaceutical company's quality team identifies a contamination issue in a batch of medication. They provide detailed reports to regulatory bodies, defining the recall scope, and ensuring all affected products are identified and recalled efficiently.

The PR Team is involved in the product recall method from a communication perspective, managing brand perception, and ensuring transparent communication with end users. They are responsible for crafting and sending notifications to end users, explaining the recall, and providing necessary instructions. Their role is vital in maintaining the company's reputation and managing public relations during the recall. Developing and implementing crisis communication plans to manage the recall announcement and subsequent updates.

An automotive manufacturer's PR team drafts a press release and sends notifications to vehicle owners, explaining the safety recall and instructing them on the steps to return the affected vehicles.

The product recall method typically begins with the Quality Team/Regulatory identifying a product issue and defining the scope of the recall. They provide essential inputs on the type and scale of the recall, ensuring all quality and regulatory criteria are considered. For instance, upon detecting a batch of contaminated food products, the quality team immediately determines the recall's extent and informs the necessary regulatory bodies.

Next, customer support steps in, leveraging multi-channel communication platforms to reach out to end users and distributors. They gather product information from multiple sources, compile effective consignment lists, and ensure all affected products are tracked accurately. In a practical scenario, a consumer electronics company's customer support team might use a CRM system to contact customers who purchased a defective batch of products, providing them with detailed instructions on returning the products.

Simultaneously, the PR Team manages the communication aspect, crafting messages to be sent to end users and other stakeholders. They ensure that the recall information is conveyed transparently and efficiently, maintaining the company's reputation and managing brand perception. For example, an automotive manufacturer's PR team might draft a press release and send notifications to vehicle owners, explaining the safety recall and instructing them on the steps to return the affected vehicles.

Throughout the product recall method, the Quality Team/Regulatory maintains visibility at each stage, monitoring progress and estimating recall efficiency. They ensure that all actions comply with regulatory requirements and that the recall is conducted efficiently. This team's involvement is crucial in providing proof of action and closing the recall once all criteria are met.

By involving these key personas-Customer Support, Quality Team/Regulatory, and PR Team—the product recall method is managed comprehensively and effectively. Each persona's unique expertise and responsibilities ensure that the recall is executed with precision, transparency, and compliance, ultimately safeguarding consumer safety and maintaining product integrity.

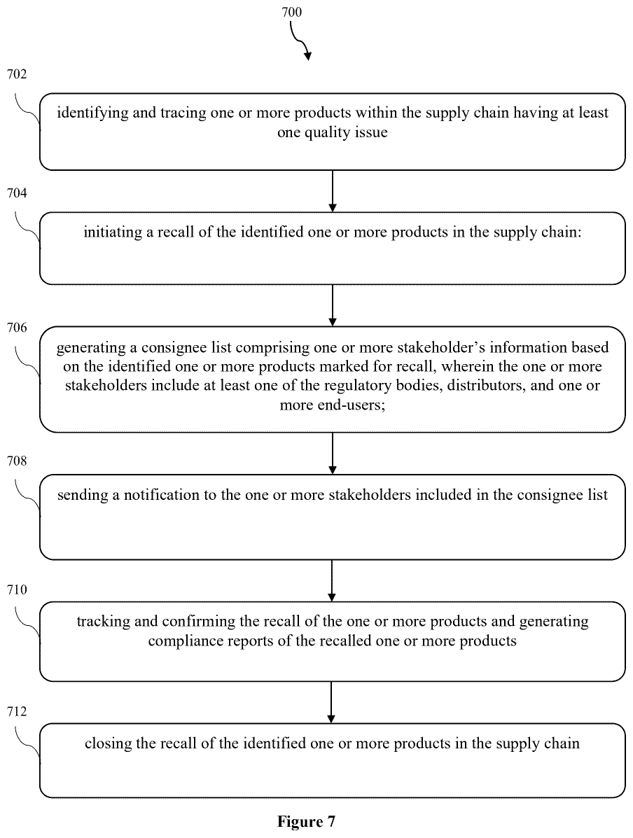

FIG. 7 illustrates a flowchart of a method for managing product recalls within a supply chain according to an embodiment of the disclosure. The steps of the method 700, described in connection with the embodiments disclosed herein, may be embodied directly in hardware, in firmware, in a software module executed by a system 800, or in any practical combination thereof.

At step 702, one or more products within the supply chain having at least one quality issue are identified and traced. In an embodiment, initiating the recall of the identified one or more products includes one or more batches of products correlated to the recalled one or more products. In another embodiment, the step of identifying includes categorizing a recall class and type of recall for the identified one or more products within the supply chain. In some examples, the identification of the quality issues is done by investigating different data sources and pinpointing the products in question. The identification process is critical as it sets the foundation for the entire recall management process. In one embodiment, method 700 utilizes advanced machine learning algorithms to analyze historical data and predict potential quality issues before they become widespread. These algorithms identify patterns and anomalies in the data that indicate a defect or quality issue, allowing for proactive measures to be taken. In another embodiment, the Quality Assessment Team and Root Cause Analysis (RCA) team are responsible for identifying quality-related issues.

In another embodiment, Internet of Thing (IoT) devices are integrated to provide real-time data on device performance and quality. These devices can continuously monitor various parameters such as temperature, humidity, pressure, and other environmental factors that might affect the device's quality. By analyzing this real-time data, deviations from expected performance standards is detected, triggering alerts for further investigation. In an exemplary embodiment, a sudden spike in temperature in a medical product could indicate a malfunction, prompting immediate action to prevent potential harm to patients.

In an embodiment, the quality issues identification may incorporate feedback mechanisms from end-users and field data reports. This includes collecting and analyzing customer complaints, warranty claims, and service reports. In an exemplary embodiment, the method 700 employs natural language processing (NLP) to sift through textual data from these sources, identifying recurring issues that could signify a broader problem. By triangulating data from multiple sources—historical trends, real-time monitoring, and user feedback—the method 700 ensures a robust and comprehensive approach to identifying quality issues.

At step 704, a recall of the identified one or more products in the supply chain is initiated. In an exemplary embodiment, the recall initiation includes identifying the batches of affected products and determining the locations of consignments within the supply chain. A comprehensive list of all affected products and their locations is generated to ensure thorough coverage. In an alternate embodiment, the method 700 uses blockchain technology to track and verify the location data.

At step 706, the recall of the identified one or more products in the supply chain is initiated by generating a consignee list comprising one or more stakeholder's information based on the identified one or more products marked for recall, where the one or more stakeholders include at least one of the regulatory bodies, distributors, and one or more end-users. In an embodiment, the information related to the one or more stakeholders comprises at least one of information related to the identified one or more products, information related to products corresponding to the batches of the identified one or more products, information related to the location of all consignments in the supply chain, and information relates to all end-users. In an embodiment, generating the consignee list comprises filtering products based on a batch identity (ID) of the identified or more products, the range of manufacturing date of the identified one or more products, and multiple UID/UID ranges of the identified one or more products; and generating information on the filtered products including product location information within the supply chain.

In an embodiment, the consignee list is generated by identifying batches of all products and determining the locations of all consignments within the supply chain. In an exemplary embodiment, completing the consignee list involves generating a comprehensive list of all patients or users and connecting with different systems to gather the necessary data. This ensures that the recall can be efficiently and accurately executed by providing a detailed account of all affected products and their locations.

In one embodiment, the method 700 employs an integrated database that consolidates information from various sources, such as warehouse management systems, distributor records, and end-user registrations. By using unique identifiers like batch IDs, manufacturing dates, and UID ranges, the method filters and retrieves specific product details. This integrated approach ensures that all relevant data points are captured, providing a holistic view of the distribution network and facilitating the accurate identification of consignees.

Another embodiment includes leveraging advanced data analytics to cross-reference and verify the accuracy of the consignee information. The discrepancies and inconsistencies can be detected by comparing data from multiple sources, such as internal records, third-party logistics (3PL) providers, and end-user feedback. This ensures that the consignee list is accurate and up-to-date, minimizing the risk of overlooking affected products.

In an embodiment, the consignee list completion includes provisions for handling products that are not traceable. In such cases, immediate audit actions are initiated to locate these products and include them in the product recall method. This ensures that all stakeholders are promptly and accurately informed about the recall, facilitating a coordinated and efficient response. The entire process is overseen by a quality team, business head, PR head, and customer support, ensuring that all notifications are approved and dispatched through various communication channels such as email, SMS, and print, as necessary.

The recall of the identified one or more products in the supply chain is initiated by further sending a notification to the one or more stakeholders included in the consignee list, step 708. Further, tracking and confirming the recall of the one or more products and generating compliance reports of the recalled one or more products, step 710. In an embodiment, tracking and confirming the recall of the one or more products comprises managing the logistics of the recalled one or more products, tracking status of the reverse logistics operations, and confirming the receipt of returned one or more products. In an embodiment, generating the compliance reports of the recalled one or more products comprises generating reports on efficiency and compliance of the recalled products, providing proof of action and proof of destruction of the recalled products by the regulatory bodies, and documenting the closure of the recalled products.

In another embodiment, digital communication methods such as emails or SMS may be used alongside physical mail to ensure broader reach and automatic reminders for unacknowledged notifications.

In one embodiment, step 708 involves sending notifications to one or more stakeholders, which includes methods that can ensure effective communication and compliance. In an embodiment, sending the notification to the one or more stakeholders comprises sending physical and electronic messages to the stakeholders, providing one or more templates for regulatory notifications, and tracking acknowledgement of the notifications from the stakeholders.

In an embodiment, the notifications sending includes sending both physical and electronic messages tailored to reach stakeholders through diverse communication channels. Additionally, the process may utilize one or more templates specifically designed for regulatory notifications, ensuring clarity and conformity with regulatory requirements. Furthermore, step 708 entails tracking the acknowledgement of these notifications from stakeholders, thereby ensuring accountability and compliance throughout the notification process. Step 120 entails reverse logistic confirmation. In an embodiment, the reverse logistic confirmation is received from one or more stakeholders. At step 712, the recall of the identified one or more products in the supply chain is closed. In an embodiment, the method also comprises displaying status of ongoing recalls of one or more products on a dashboard within a user interface. In an another embodiment, the method further comprises communicating with one or more regulatory bodies regarding the identification of the quality issues with one or more products and managing the recall of the one or more products.

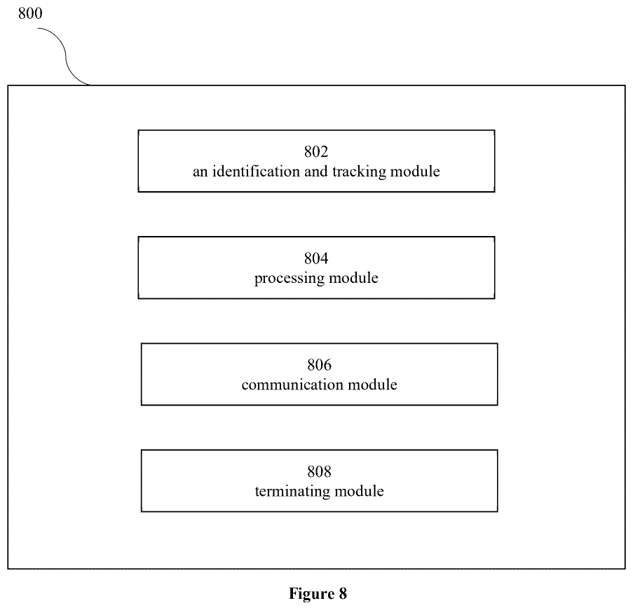

FIG. 8 illustrates a recall management system 800 according to an embodiment of the disclosure. The recall management system 800 includes an identification and tracking module 802, a processing module 804, a communication module 806, and a terminating module 808. The identification and tracking module 802 configured to identify and trace one or more products within the supply chain having at least one quality issue. The processing module 804 is configured to initiate a recall of the identified one or more products in the supply chain by generating a consignee list comprising one or more stakeholder's information based on the identified one or more products marked for recall, where the one or more stakeholders include at least one of the regulatory bodies, distributors, and one or more end-users. The processing module 804 is further configured to track and confirm the recall of the one or more products and generate compliance reports of the recalled one or more products. The communication module 806 being in operative communication with the processing module 804, configured to send a notification to the one or more stakeholders included in the consignee list. The terminating module 808 is configured to close the recall of the identified one or more products in the supply chain.

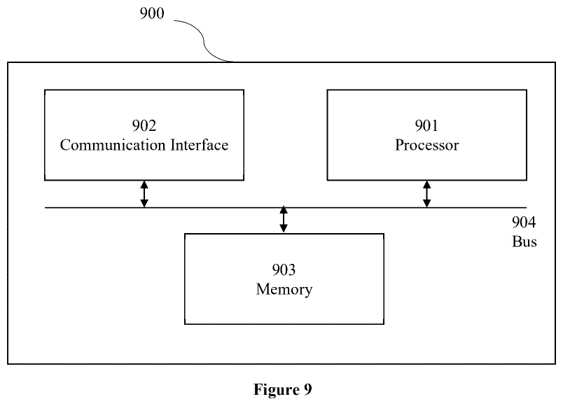

FIG. 9 illustrates a schematic diagram of another communication apparatus 900 according to an embodiment of the disclosure. The communication apparatus 900 includes a processor 901, a communication interface 902, and a memory 903. The processor 901, the communication interface 902, and the memory 903 may be connected to each other via a bus 904. The bus 904 may be a peripheral component interconnect (peripheral component interconnect, PCI) bus, an extended industry standard architecture (extended industry standard architecture, EISA) bus, or the like. The bus 904 may be classified into an address bus, a data bus, a control bus, and the like. For ease of representation, the bus is represented by using only one line in FIG. 9, but it does not indicate that there is only one bus or one type of bus. The processor 901 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 903 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for managing product recalls within a supply chain, comprising the steps of:
identifying and tracing one or more products within the supply chain having at least one quality issue;
initiating a recall of the identified one or more products in the supply chain by:
generating a consignee list comprising one or more stakeholder's information based on the identified one or more products marked for recall, wherein the one or more stakeholders include at least one of the regulatory bodies, distributors, and one or more end-users;
sending a notification to the one or more stakeholders included in the consignee list; and
tracking and confirming the recall of the one or more products and
generating compliance reports of the recalled one or more products; and
closing the recall of the identified one or more products in the supply chain.

2. The method as claimed in claim 1, wherein initiating the recall of the identified one or more products includes one or more batches of products correlated to the recalled one or more products.

3. The method as claimed in claim 1, wherein the step of identifying includes categorizing a recall class and type of recall for the identified one or more products within the supply chain.

4. The method as claimed in claim 1, wherein the information related to the one or more stakeholders comprises at least one of:
information related to the identified one or more products;
information related to products corresponding to the batches of the identified one or more products;
information related to the location of all consignments in the supply chain; and
information relates to all end-users.

5. The method as claimed in claim 1, further comprising displaying status of ongoing recalls of one or more products on a dashboard within a user interface.

6. The method as claimed in claim 1, wherein sending the notification to the one or more stakeholders, comprises:
sending physical and electronic messages to the stakeholders;
providing one or more templates for regulatory notifications; and
tracking acknowledgement of the notifications from the stakeholders.

7. The method as claimed in claim 1, wherein tracking and confirming the recall of the one or more products comprises:
managing the logistics of the recalled one or more products;
tracking status of the reverse logistics operations; and
confirming the receipt of returned one or more products.

8. The method as claimed in claim 1, wherein generating the compliance reports of the recalled one or more products comprises:
generating reports on efficiency and compliance of the recalled products;
providing proof of action and proof of destruction of the recalled products by the regulatory bodies; and
documenting the closure of the recalled products.

9. The method as claimed in claim 1, wherein generating the consignee list comprises:
filtering products based on a batch identity (ID) of the identified or more products, range of manufacturing date of the identified one or more products, and multiple UID/UID range of the identified one or more products; and
generating information on the filtered products including product location information within the supply chain.

10. The method as claimed in claim 1, further comprising communicating with one or more regulatory bodies regarding the identification of the quality issues with one or more products and managing the recall of the one or more products.

11. A recall management system for managing product recalls within a supply chain, comprising:
an identification and tracking module configured to identify and trace one or more products within the supply chain having at least one quality issue;
a processing module configured to initiate a recall of the identified one or more products in the supply chain by generating a consignee list comprising one or more stakeholder's information based on the identified one or more products marked for recall, wherein the one or more stakeholders include at least one of the regulatory bodies, distributors, and one or more end-users; the processing module further configured to track and confirm the recall of the one or more products and generate compliance reports of the recalled one or more products;
a communication module being in operative communication with the processing module, configured to send a notification to the one or more stakeholders included in the consignee list; and
a terminating module configured to close the recall of the identified one or more products in the supply chain.

12. The system as claimed in claim 11, wherein the processing module configured to generate the consignee list including the information related to the one or more stakeholders comprising at least one of:
information related to the identified one or more products;
information related to products corresponding to the batches of the identified one or more products;
information related to the location of all consignments in the supply chain; and
information relates to all end-users.

13. The system as claimed in claim 11, wherein the system being in operative communication with a user interface, configured to display a status of ongoing recalls of one or more products on a dashboard.

14. The system as claimed in claim 11, wherein the processing module configured to send the notification to the one or more stakeholders, comprising:
sending physical and electronic messages to the stakeholders;
providing one or more templates for regulatory notifications; and
tracking acknowledgement of the notifications from the stakeholders.

15. The system as claimed in claim 11, wherein the processing module configured to track and confirm the recall of the one or more products, comprising:
managing the logistics of the recalled one or more products;
tracking status of the reverse logistics operations; and
confirming the receipt of returned one or more products.

16. The system as claimed in claim 11, wherein the processing module configured to generate the compliance reports of the recalled one or more products, comprising:
generating reports on efficiency and compliance of the recalled products;
providing proof of action and proof of destruction of the recalled products by the regulatory bodies; and
documenting the closure of the recalled products.

17. The system as claimed in claim 11, wherein the processing module configured to generate the consignee list, comprising:
filtering products based on a batch identity (ID) of the identified or more products, range of manufacturing date of the identified one or more products, and multiple UID/UID range of the identified one or more products; and
generating information on the filtered products including product location information within the supply chain.

18. The system as claimed in claim 11, wherein the processing module configured to initiate a recall of the identified one or more products includes one or more batches of products correlated to the recalled one or more products.

19. The system as claimed in claim 11, wherein the communication module further configured to communicate with one or more regulatory bodies regarding the identification of the quality issues with one or more products and aiding the recall of the one or more products.

20. A non-transitory computer-readable medium having stored thereon computer-readable instructions that, when executed by a processor, cause the processor to execute a method for managing product recalls within a supply chain, comprising:
identify and trace one or more products within the supply chain having at least one quality issue;
initiate a recall of the identified one or more products in the supply chain comprising:
generate a consignee list comprising one or more stakeholder's information based on the identified one or more products marked for recall, wherein the one or more stakeholders include at least one of the regulatory bodies, distributors, and one or more end-users;
send a notification to the one or more stakeholders included in the consignee list; and
track and confirm the recall of the one or more products and generate compliance reports of the recalled one or more products; and
close the recall of the identified one or more products in the supply chain.
